(19) United States
(12) Patent Application Publication
(10) Pub. No.: US 2017/0267817 A1
(43) Pub. Date: Sep. 21, 2017

(54) METHOD AND COMPOSITION INCLUDING THERMOPLASTIC PARTICLES AND HOLLOW MICROSPHERES AND ARTICLES MADE FROM THEM

(71) Applicant: 3M INNOVATIVE PROPERTIES COMPANY, St. Paul, MN (US)

(72) Inventors: Baris Yalcin, Roswell, GA (US); Ibrahim S. Gunes, Minneapolis, MN (US); Kristin L. Thunhorst, Stillwater, MN (US)

(21) Appl. No.: 15/505,802

(22) PCT Filed: Aug. 14, 2015
(86) PCT No.: PCT/US2015/045195

§ 371 Date: Feb. 22, 2017

Related U.S. Application Data
(60) Provisional application No. 62/040,605, filed on Aug. 22, 2014.

(51) Int. Cl. C08J 3/20; B29B 7/02; B29C 41/46; B29B 7/90; B29C 41/04; B29C 41/22

(52) U.S. Cl. CPC C08J 3/203; B29C 41/04; B29C 41/22; B29C 41/46; B29B 7/90; B29B 7/02; B29K 2105/165

(57) ABSTRACT

A method of making a molded article. The method includes introducing into a mold a composition including thermoplastic particles with hollow microspheres attached to their outer surfaces, rotating the mold, and heating the mold at a temperature at which the thermoplastic particles melt. The hollow microspheres are included in the molded article. Molded articles are also disclosed. A powder composition that includes thermoplastic powder particles and hollow ceramic microspheres attached to outer surfaces of at least some of the thermoplastic powder particles is also disclosed. The hollow ceramic microspheres are either adhered to the outer surfaces of at least some of the thermoplastic powder particles with a liquid or embedded in the outer surfaces of at least some of the thermoplastic powder particles.

### CROSS-REFERENCE TO RELATED APPLICATION

This application claims priority to U.S. Provisional Application No. 62/040,605, filed Aug. 22, 2014, the disclosure of which is incorporated by reference in its entirety herein.

### BACKGROUND

Hollow glass microspheres having an average diameter of less than about 500 micrometers, also commonly known as “glass microbubbles”, “glass bubbles”, “hollow glass beads”, or “glass balloons” are widely used in industry, for example, as additives to polymeric compositions. In many industries, hollow glass microspheres are useful, for example, for lowering weight and improving processing, dimensional stability, and flow properties of a polymeric composition.

The incorporation of hollow ceramic microspheres and hollow glass microspheres into polymeric articles made by rotational molding has been suggested in U.S. Pat. Appl. Pub. Nos. 2001/0041233 (Rusche) and 2008/0224349 (Wang et al.), respectively.

### SUMMARY

A problem with incorporating hollow microspheres into a rotational molding process is that hollow microspheres can be a significant source of dust. Also, we have found that it can be difficult to achieve a uniform dispersion of hollow microspheres in a rotationally molded article. The present disclosure provides compositions and methods in which hollow microspheres are disposed on the outer surfaces of thermoplastic particles. The compositions are useful, for example, for rotationally molding articles.

In one aspect, the present disclosure provides a method of making a molded article. The method includes introducing into a mold a composition including thermoplastic particles and hollow microspheres, rotating the mold, and heating the mold at a temperature at which the thermoplastic particles melt. The hollow microspheres are attached to outer surfaces of the thermoplastic particles when the composition is introduced into the mold (that is, before rotating and heating the mold).

In another aspect, the present disclosure provides a powder composition including thermoplastic powder particles and hollow ceramic microspheres attached to outer surfaces of at least some of the thermoplastic powder particles. The hollow ceramic microspheres are adhered to the outer surfaces of at least some of the thermoplastic powder particles with a liquid. Or the hollow ceramic microspheres are embedded in and protrude from the outer surfaces of at least some of the thermoplastic powder particles.

Typically and advantageously, when hollow microspheres are attached to the outer surfaces of thermoplastic particles, low dusting has been observed, for example, when such compositions are added to a mold for rotational molding. The compositions typically can be transported and used without significant segregation of the hollow microspheres from the thermoplastic particles. Furthermore, low hollow ceramic microsphere breakage is observed in articles made from such compositions.

Compositions and methods according to the present disclosure allow hollow microspheres to be handled in large quantities in environments that typically offer little protection from the adverse effects of dust. Accordingly, these compositions and methods are useful for rotationally molding large objects.

In another aspect, the present disclosure provides a kayak comprising hollow microspheres.

In another aspect, the present disclosure provides a pressure vessel comprising hollow microspheres.

In another aspect, the present disclosure provides a garbage collection cart comprising hollow microspheres.

In another aspect, the present disclosure provides a playhouse or portion thereof comprising hollow microspheres.

The hollow microspheres in any of the kayak, pressure vessel or portion thereof, garbage collection cart, or playhouse or portion thereof can be polymeric or ceramic (e.g., glass) microspheres. In some embodiments, the hollow microspheres are hollow ceramic microspheres. In some of these embodiments, the hollow microspheres are hollow glass microspheres.

In this application, terms such as “a”, “an” and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and integral and non-integral values between the endpoints unless otherwise stated (e.g. 1 to 5 includes 1, 1.5, 2, 2.75, 3, 3.80, 4, and 5).

The term “ceramic” as used herein refers to glasses, crystalline ceramics, glass-ceramics, and combinations thereof.

The above summary of the present disclosure is not intended to describe each disclosed embodiment or every implementation of the present disclosure. The description that follows more particularly exemplifies illustrative embodiments. It is to be understood, therefore, that the following description should not be read in a manner that would unduly limit the scope of this disclosure.

### BRIEF DESCRIPTION OF THE DRAWINGS

FIG. 1 is a micrograph at a magnification of 415× of high density polyethylene powder mixed with hollow glass microspheres;

FIG. 2 is a micrograph at a magnification of 2060× of hollow glass microspheres adhered to a high density polyethylene powder particle with mineral oil; and

FIG. 3 is a micrograph at a magnification of 1080× of hollow glass microspheres embedded into the outer surface of a high density polyethylene powder particle.

### DETAILED DESCRIPTION

Rotational molding, which is also commonly referred to as rotomolding, is a process for molding polymers useful, for example, in the production of large, hollow objects, such as storage tanks (as discussed, for example, in Chapter 1 of the authoritative textbook Rotational Molding Technology by R J Crawford and J L Throne, WILLIAM ANDREW PUBLISHING, Norwich, N.Y., 2002). The rotomolding process typically includes placing the thermoplastic resin, in solid or liquid form, into a closed mold, heating the mold until the resin melts or acquires proper flow characteristics, rotating the mold (e.g., about two perpendicular axes, that is, biaxially) until the resin uniformly coats the interior surfaces of the mold, cooling the mold, and removing the article from the mold.

For many rotomolded articles, the molds have significantly large volumes (e.g., up to 100 cubic meters). In most operations, the molds are manually charged with polymer powder before each molding cycle, and most rotomolding facilities are not equipped with local exhaust ventilation. Thus, a clean and essentially dust-free rotomolding operation is highly desirable.

Since many rotomolding articles are quite large, the incorporation of hollow microspheres into the articles would provide an advantageous weight reduction. Rotomolding is a low shear and low pressure processing operation; therefore, many types of hollow microspheres may be useful in the process. However, hollow microspheres can be a significant source of dust. In the case of processes other than rotomolding (e.g. injection molding) the current state of the art of using hollow glass microspheres is a prior melt compounding step with polymer pellets in a twin screw extruder. Pellets including the polymer and the hollow microspheres obtained from the melt compounding are later used in injection molding process to create articles which contain the hollow microspheres. However, this prior compounding increases the manufacturing cost of the final article and complicates supply chain operations. Advantageously, in the compositions and methods of the present disclosure, melt compounding before a molding process, while possible, is not required.

The present disclosure provides compositions including thermoplastic particles and hollow microspheres that may be useful, for example, for rotomolding or injection molding. Suitable thermoplastics may be selected by those skilled in the art, depending, for example, on the desired molded product. Examples of useful thermoplastics include polyolefins (e.g., polypropylene, polyethylene, and polyolefin copolymers such as ethylene-butene, ethylene-octene, and ethylene vinyl alcohol); fluorinated polyolefins (e.g., polytetrafluoroethylene, copolymers of tetrafluoroethylene and hexafloropropylene (FEP), perfluoroalkoxy polymer resin (PFA), polychlorotrifluoroethylene (pCTFE), copolymers of ethylene and chlorotrifluoroethylene (pECTFE), and copolymers of ethylene and tetrafluoroethylene (PETFE)); polyamide; polyamide-imide; polyether-imide; polyetherketone resins; polystyrenes; polystyrene copolymers (e.g., high impact polystyrene, acrylonitrile butadiene styrene copolymer (ABS)); polyacrylates; polymethacrylates; polyesters (e.g., unsaturated polyesters); polyvinylchloride (PVC); liquid crystal polymers (LCP); polyphenylene sulfides (PPS); polysulfones; polyacetals; polycarbonates; polyphenylene oxides; and blends of two or more such resins. In some embodiments, the thermoplastic particles comprise at least one of polypropylene or polyethylene (e.g., high density polyethylene (HDPE), low density polyethylene (LDPE), linear low density polyethylene (LLDPE), polypropylene (PP)), and polyolefin copolymers (e.g., copolymers of propylene and ethylene). In some of these embodiments, the thermoplastic is polyethylene (e.g., ultra high molecular weight polyethylene, high density polyethylene (HDPE), low density polyethylene (LDPE), and linear low density polyethylene (LLDPE)). High density polyethylene typically has a density from about 0.94 g/cm³ to about 0.98 g/cm³, and linear or branched low-density polyethylenes typically have a density from about 0.89 g/cm³ to about 0.94 g/cm³). In some embodiments, the thermoplastic is a polyamide (e.g., polyamide 6 or polyamide 66).

In some embodiments, the thermoplastic in the particles useful in the compositions and methods disclosed herein is crosslinkable, forming a thermoset in the final molded article. Examples of such particles include those from melt-processable epoxy resins, polyester resins, polyurethane resins, polyurea resins, silicone resins, polysulfide resins, and phenolic resins. In these embodiments, suitable crosslinkers may be added to the composition or during the molding process to form the crosslinked, molded article. In some embodiments, the thermoplastic in the particles useful in the composition and methods disclosed herein is a polyolefin, which is crosslinkable. Polyolefin particles may be crosslinkable in the presence of a peroxide or sulfonyl hydrazide crosslinking agent, which can be added to the polyolefin particles or powder before or during grinding. Examples of suitable crosslinking agents include dicumyl peroxide, benzoyl peroxide, 1,10-decane-bis(sulfonyl hydrazide), 1,1-di-tert-butyl peroxy-3,3,5-trimethyl cyclohexane, 2,5-dimethyl-2,5-di(tert-butyl peroxy) hexane, tert-butyl-cumyl peroxide, α,α′-di(butyl peroxy)-diisoproyl benzene, and 2,5-dimethyl-2,5-di(tert-butyl peroxy) hexyne. When the composition is heated, the crosslinking agents decompose to form free-radical species, which can abstract a hydrogen from the polyolefin chain to form a crosslinking sight. The term “crosslinked” refers to joining polymer chains together by covalent chemical bonds, usually via crosslinking molecules or groups, to form a network polymer. Therefore, a chemically non-crosslinked polymer is a polymer that lacks polymer chains joined together by covalent chemical bonds to form a network polymer. A crosslinked polymer is generally characterized by insolubility, but may be swellable in the presence of an appropriate solvent. A non-crosslinked polymer is typically soluble in certain solvents and is typically melt-processable. A polymer that is chemically non-crosslinked may also be referred to as a linear polymer. A melt-processable polymer that is chemically non-crosslinked may also be referred to as a thermoplastic.

Advantageously, the thermoplastic particles in the compositions disclosed herein can be in the form of a powder. A powder refers to fine solid particles as would be understood by a person skilled in the art. In a powder, there is generally a distribution of sizes of the powder particles. The size distribution of the thermoplastic powder particles useful for practicing the present disclosure may be Gaussian, normal, or non-normal. Non-normal distributions may be unimodal or multi-modal (e.g., bimodal). In some embodiments, the thermoplastic powder particles can have a median size by volume up to or less than 1000 micrometers (in some embodiments up to 750 micrometers or 500 micrometers). The median size is also called the D50 size, where 50 percent by volume of the thermoplastic powder particles in the distribution are smaller than the indicated size. The size refers to the largest dimension of the thermoplastic powder particles. In some embodiments, the median size by volume of the thermoplastic powder particles is in a range from 600 micrometers to 1000 micrometers (i.e., about 30 mesh to about 18 mesh), 425 micrometers to 850 micrometers (i.e., about 40 mesh to about 20 mesh), 300 micrometers to 600 micrometers (i.e., about 50 mesh to about 30 mesh), or 300 micrometers to 1000 micrometers (i.e., about 50 mesh to about 18 mesh). In some embodiments, the sphericity (that is, the ratio of the surface area of a sphere with the same volume as the particle to the surface area of the particle) of the powder particle is at least 0.6 (in some embodiments, at least 0.7, 0.8, or 0.9). For spherical powder particles, the size of the particles is understood to be synonymous with the height and diameter of the particles.

Powder particles are generally known to be distinguishable from fibers and pellets. Thermoplastic pellets have a median or mean particle size of at least 1000 micrometers, 2000 micrometers, or 3000 micrometers or more. Thermoplastic fibers have an aspect ratio, defined as the ratio of fiber length to diameter, of at least 10:1, 20:1, 60:1, or higher. Using pellets or fibers for rotomolding would be disadvantageous because such materials would be difficult to melt and may fuse unevenly to make a molded part including extensive air pockets.

Powder particles are useful for rotomolding because, among other things, they can be melted more easily than pellets or fibers with low degradation in the mold, can provide a high quality surface finish with relatively few pinholes, and can provide a high initial bulk density. For some of these same reasons, powders are also useful for some other polymer processing methods (e.g., injection molding). However, polymer powders are more expensive than pellets, can be considered an explosion hazard, and present handling difficulties. For at least these reasons, powders are sometimes avoided when pellets can readily be used.

The powder composition according to the present disclosure can generally be understood to be a dry powder composition. The term “dry” refers to the powder composition not being dispersed in water or an organic liquid. Dry powders are handled differently from pastes and slurries of particles in a liquid. Any liquid that may be present in the powder compositions according to the present disclosure is typically located between the surfaces of the hollow microspheres and the thermoplastic powder particles. In some embodiments, the dry powder compositions and compositions including thermoplastic particle and hollow microspheres according to the present disclosure have up to 15 (in some embodiments, less than 15 or up to 10, 7.5, or 5) percent by weight of a liquid, based on the total weight of the composition. In some embodiments, the dry powder compositions and compositions including thermoplastic particle and hollow microspheres according to the present disclosure have a weight percent of a liquid that is up to 2, 1.5, or 1 times the weight percent of the hollow microspheres in the composition.

Compositions according to the present disclosure and/or useful for practicing the methods and articles disclosed herein also include hollow microspheres. The hollow microspheres useful for practicing the present disclosure generally are those that are able to survive the rotomolding process (e.g., without being crushed or melted) and therefore are found in the molded article. A lower density in the molded article can provide evidence for the hollow microspheres surviving the process and being found in the molded article. Further evidence for the incorporation of hollow microspheres in the molded article can be obtained by cutting through the molded article and observing the cut surface with a microscope. To survive the rotomolding process, the hollow microspheres typically should have a higher melting point than the thermoplastic particles and should be able to withstand the typically long heating cycles used in rotomolding Useful hollow microspheres include those made from certain polymers and ceramics (e.g., glass).

In some embodiments, the hollow microspheres useful for practicing the present disclosure are hollow glass microspheres. Hollow glass microspheres useful in the compositions and methods according to the present disclosure can be made by techniques known in the art (see, e.g., U.S. Pat. No. 2,978,340 (Veatch et al.); U.S. Pat. No. 3,030,215 (Veatch et al.); U.S. Pat. No. 3,129,086 (Veatch et al.); and U.S. Pat. No. 3,230,064 (Veatch et al.); U.S. Pat. No. 3,365,315 (Beck et al.); U.S. Pat. No. 4,391,646 (Howell); and U.S. Pat. No. 4,767,726 (Marshall); and U. S. Pat. App. Pub. No. 2006/0122049 (Marshall et. al). Techniques for preparing hollow glass microspheres typically include heating milled frit, commonly referred to as “feed”, which contains a blowing agent (e.g., sulfur or a compound of oxygen and sulfur). Frit can be made by heating mineral components of glass at high temperatures until molten glass is formed.

Although the frit and/or the feed may have any composition that is capable of forming a glass, typically, on a total weight basis, the frit comprises from 50 to 90 percent of SiO₂, from 2 to 20 percent of alkali metal oxide, from 1 to 30 percent of B₂O₃, from 0.005-0.5 percent of sulfur (for example, as elemental sulfur, sulfate or sulfite), from 0 to 25 percent divalent metal oxides (for example, CaO, MgO, BaO, SrO, ZnO, or PbO), from 0 to 10 percent of tetravalent metal oxides other than SiO₂ (for example, TiO₂, MnO₂, or ZrO₂), from 0 to 20 percent of trivalent metal oxides (for example, Al₂O₃, Fe₂O₃, or Sb₂O₃), from 0 to 10 percent of oxides of pentavalent atoms (for example, P₂O₅ or V₂O₅), and from 0 to 5 percent fluorine (as fluoride) which may act as a fluxing agent to facilitate melting of the glass composition. Additional ingredients are useful in frit compositions and can be included in the frit, for example, to contribute particular properties or characteristics (for example, hardness or color) to the resultant glass bubbles.

In some embodiments, the hollow glass microspheres useful in the compositions and methods according to the present disclosure have a glass composition comprising more alkaline earth metal oxide than alkali metal oxide. In some of these embodiments, the weight ratio of alkaline earth metal oxide to alkali metal oxide is in a range from 1.2:1 to 3:1. In some embodiments, the hollow glass microspheres have a glass composition comprising B₂O₃ in a range from 2 percent to 6 percent based on the total weight of the glass bubbles. In some embodiments, the hollow glass microspheres have a glass composition comprising up to 5 percent by weight Al₂O₃, based on the total weight of the hollow glass microspheres. In some embodiments, the glass composition is essentially free of Al₂O₃. “Essentially free of Al₂O₃” may mean up to 5, 4, 3, 2, 1, 0.75, 0.5, 0.25, or 0.1 percent by weight Al₂O₃. Glass compositions that are “essentially free of Al₂O₃” also include glass compositions having no Al₂O₃. Hollow glass microspheres useful for practicing the present disclosure may have, in some embodiments, a chemical composition wherein at least 90%, 94%, or even at least 97% of the glass comprises at least 67% SiO₂, (e.g., a range of 70% to 80% SiO₂), a range of 8% to 15% of an alkaline earth metal oxide (e.g., CaO), a range of 3% to 8% of an alkali metal oxide (e.g., Na₂O), a range of 2% to 6% B₂O₃, and a range of 0.125% to 1.5% SO₃. In some embodiments, the glass comprises in a range from 30% to 40% Si, 3% to 8% Na, 5% to 11% Ca, 0.5% to 2% B, and 40% to 55% O, based on the total of the glass composition.

The “average true density” of hollow glass microspheres is the quotient obtained by dividing the mass of a sample of hollow glass microspheres by the true volume of that mass of hollow glass microspheres as measured by a gas pycnometer. The “true volume” is the aggregate total volume of the hollow glass microspheres, not the bulk volume. The average true density of the hollow glass microspheres useful for practicing the present disclosure is generally at least 0.20 grams per cubic centimeter (g/cc), 0.25 g/cc, or 0.30 g/cc. In some embodiments, the hollow glass microspheres useful for practicing the present disclosure have an average true density of up to about 0.65 g/cc. “About 0.65 g/cc” means 0.65 g/cc±five percent. In some of these embodiments, the average true density of the hollow glass microspheres disclosed herein may be in a range from 0.1 g/cc to 0.65 g/cc, 0.2 g/cc to 0.65 g/cc, 0.1 g/cc to 0.5 g/cc, 0.3 g/cc to 0.65 g/cc, or 0.3 g/cc to 0.48 g/cc. Hollow glass microspheres having any of these densities can be useful for lowering the density of molded articles according to the present disclosure and/or made according to the methods disclosed herein.

For the purposes of this disclosure, average true density is measured using a pycnometer according to ASTM D2840-69, “Average True Particle Density of Hollow Microspheres”. The pycnometer may be obtained, for example, under the trade designation “ACCUPYC 1330 PYCNOMETER” from Micromeritics, Norcross, Ga., or under the trade designations “PENTAPYCNOMETER” or “ULTRAPYCNOMETER 1000” from Formanex, Inc., San Diego, Calif. Average true density can typically be measured with an accuracy of 0.001 g/cc. Accordingly, each of the density values provided above can be ±five percent.

A variety of sizes of hollow glass microspheres may be useful. As used herein, the term size is considered to be equivalent with the diameter and height of the hollow glass microspheres. In some embodiments, the hollow glass microspheres can have a median size by volume in a range from 14 to 70 micrometers (in some embodiments from 15 to 65 micrometers, 15 to 60 micrometers, or 20 to 50 micrometers). The median size is also called the D50 size, where 50 percent by volume of the hollow glass microspheres in the distribution are smaller than the indicated size. For the purposes of the present disclosure, the median size by volume is determined by laser light diffraction by dispersing the hollow glass microspheres in deaerated, deionized water. Laser light diffraction particle size analyzers are available, for example, under the trade designation “SATURN DIGISIZER” from Micromeritics. The size distribution of the hollow glass microspheres useful for practicing the present disclosure may be Gaussian, normal, or non-normal. Non-normal distributions may be unimodal or multi-modal (e.g., bimodal).

Since rotomolding is a generally a low shear and low pressure process, many hollow glass microspheres are strong enough to survive the rotomolding process. A useful isostatic pressure at which ten percent by volume of the hollow glass microspheres collapses is at least about 1.7 (in some embodiments, at least about 2.0, 3.8, 5.0, or 5.5) Megapascals (MPa). “About 1.7 MPa” means 1.7 MPa±five percent. In contrast, in order to survive an injection molding process, a useful isostatic pressure at which ten percent by volume of hollow glass microspheres collapses is typically at least about 17 MPa. In some embodiments, an isostatic pressure at which ten percent by volume of the hollow glass microspheres collapses can be at least 17, 20, or 38 MPa, depending on the requirements of the final molded article. In some embodiments, an isostatic pressure at which ten percent, or twenty percent, by volume of the hollow glass microspheres collapses is up to 250 (in some embodiments, up to 210, 190, or 170) MPa. For some applications, it is useful to use the least expensive hollow glass microsphere that will meet the requirements of the final molded article. Since the cost of hollow glass microspheres generally decreases with decreasing crush strength, in some embodiments, the isostatic pressure at which ten percent by volume of hollow glass microspheres collapses is up to 17 MPa, 10 MPa, 7.5 MPa, or 5 MPa. For the purposes of the present disclosure, the collapse strength of the hollow glass microspheres is measured on a dispersion of the hollow glass microspheres in glycerol using ASTM D3102-72 “Hydrostatic Collapse Strength of Hollow Glass Microspheres”; with the exception that the sample size (in grams) is equal to 10 times the density of the glass bubbles. Collapse strength can typically be measured with an accuracy of ± about five percent. Accordingly, each of the collapse strength values provided above can be ±five percent. It should be understood by a person skilled in the art that not all hollow glass microspheres with the same density have the same collapse strength and that an increase in density does not always correlate with an increase in collapse strength.

Hollow glass microspheres useful for practicing the present disclosure can be obtained commercially and include those marketed by 3M Company, St. Paul, Minn., under the trade designation “3M GLASS BUBBLES” (e.g., grades K1, K15, S15, S22, K20, K25, S32, K37, S38, S38HS, S38XHS, K46, A16/500, A20/1000, D32/4500, H50/10000, S60, S60HS, iM30K, iM16K, S38HS, S38XHS, K42HS, K46, and H50/10000). Other suitable hollow glass microspheres can be obtained, for example, from Potters Industries, Valley Forge, Pa., (an affiliate of PQ Corporation) under the trade designations “SPHERICEL HOLLOW GLASS SPHERES” (e.g., grades 110P8 and 60P18) and “Q-CEL HOLLOW SPHERES” (e.g., grades 30, 6014, 6019, 6028, 6036, 6042, 6048, 5019, 5023, and 5028), from Silbrico Corp., Hodgkins, Ill. under the trade designation “SIL-CELL” (e.g., grades SIL 35/34, SIL-32, SIL-42, and SIL-43), and from Sinosteel Maanshan Inst. of Mining Research Co., Maanshan, China, under the trade designation “Y8000”.

In some embodiments, hollow glass microspheres useful for practicing the present disclosure are surface treated. In some embodiments, the hollow glass microspheres are surface treated with a coupling agent such as a zirconate, silane, or titanate. Typical titanate and zirconate coupling agents are known to those skilled in the art and a detailed overview of the uses and selection criteria for these materials can be found in Monte, S.J., Kenrich Petrochemicals, Inc., “Ken-React® Reference Manual—Titanate, Zirconate and Aluminate Coupling Agents”, Third Revised Edition, March, 1995. Suitable silanes are coupled to glass surfaces through condensation reactions to form siloxane linkages with the siliceous glass. The treatment renders the microspheres more wet-able or promotes the adhesion of materials to the glass bubble surface. This provides a mechanism to bring about covalent, ionic or dipole bonding between hollow glass microspheres and organic matrices. Silane coupling agents may be chosen based on the particular functionality desired. Suitable silane coupling strategies are outlined in Silane Coupling Agents: Connecting Across Boundaries, by Barry Arkles, pg 165-189, Gelest Catalog 3000-A Silanes and Silicones: Gelest Inc. Morrisville, Pa. In some embodiments, useful silane coupling agents have amino functional groups (e.g., N-2-(aminoethyl)-3-aminopropyltrimethoxysilane and (3-aminopropyl)trimethoxysilane). When the thermoplastic particles include a crosslinkable group, it may be useful to use a coupling agent that contains a polymerizable moiety, thus incorporating the material directly into the polymer backbone. Examples of polymerizable moieties are materials that contain olefinic functionality such as styrenic, vinyl (e.g., vinyltriethoxysilane, vinyltri(2-methoxyethoxy) silane), acrylic and methacrylic moieties (e.g., 3-metacrylroxypropyltrimethoxysilane). Other examples of useful silanes that may participate in crosslinking include 3-mercaptopropyltrimethoxysilane, bis(triethoxysilipropyl)tetrasulfane (e.g., available under the trade designation “SI-69” from Evonik Industries, Wesseling, Germany), and thiocyanatopropyltriethoxysilane. If used, coupling agents are commonly included in an amount of about 1 to 3% by weight, based on the total weight of the bubble.

In some embodiments, the hollow microspheres useful for practicing the present disclosure are hollow ceramic microspheres other than the glass microspheres described above. In some embodiments, the hollow ceramic microspheres are aluminosilicate microspheres extracted from pulverized fuel ash collected from coal-fired power stations (i.e., cenospheres). Useful cenospheres include those marketed by Sphere One, Inc., Chattanooga, Tenn., under the trade designation “EXTENDOSPHERES HOLLOW SPHERES” (e.g., grades SG, MG, CG, TG, HA, SLG, SL-150, 300/600, 350 and FM-1); and those marketed by SphereServices, Inc., Oak Ridge, Tenn., under the trade designations “RECYCLOSPHERES” “SG500”, “Standard Grade 300”, “BIONIC BUBBLE XL-150”, and “BIONIC BUBBLE W-300”. Cenospheres typically have true average densities in a range from 0.25 g/cm³ to 0.8 g/cm³.

In some embodiments, the hollow microspheres useful for practicing the present disclosure are hollow polymeric microspheres. Useful polymeric microspheres include phenolic microspheres available, for example, from Asia Pacific Microspheres Sdn Bhd, Selangor Dural Ehsan, Malaysia, under the trade designation “PHENOSET” and crosslinked polystyrene-co-divinylbenzene hollow microspheres available, for example, from EPRUI Nanoparticles & Microspheres Co., Ltd. Nanjing, China.

In order to reduce the weight of the final molded article, the hollow microspheres are present in the composition including thermoplastic particles and hollow microspheres disclosed herein in any of the above embodiments at a level of at least 0.5 percent by weight, based on the total weight of the composition. In some embodiments, the hollow microspheres are present in the composition at least at 1, 2, or 3 percent by weight based on the total weight of the composition. In some embodiments, the hollow microspheres are present in the composition at a level of up to 20, 15, or 10 percent by weight, based on the total weight of the composition. For example, the hollow microspheres may be present in the composition in a range from 0.5 to 20, 1 to 20, or 1 to 15 percent by weight, based on the total weight of the composition.

Since the hollow microspheres are attached (e.g., adhered to or embedded in) the outer surface of the thermoplastic particles (e.g., powder particles), the size of the thermoplastic particles is larger the size of the hollow microspheres. In some embodiments, the median size of the thermoplastic particles is at least 3, 5, or 10 times larger than the median size of the hollow microspheres. In some embodiments, the median size of the thermoplastic particles up to 100, 75, or 50 times larger than the median size of the hollow microspheres. In some embodiments, the effective top size of the thermoplastic particles is at least 3, 5, or 10 times larger than the effective top size of the hollow microspheres. In some embodiments, the effective top size of the thermoplastic particles up to 100, 75, or 50 times larger than the effective top size of the hollow microspheres. The effective top size refers to the size in which 95 percent by volume of the thermoplastic particles or hollow microspheres in the distribution are smaller than the indicated size.

In some embodiments, the hollow microspheres (in some embodiments, hollow ceramic microspheres) are embedded in the outer surfaces of at least some of the thermoplastic particles (e.g., the thermoplastic powder particles). When the hollow microspheres are embedded in the outer surfaces of at least some of the thermoplastic particles, at least some of the hollow microspheres protrude from the outer surfaces of the thermoplastic particles. An example of this embodiment is shown in the FIG. 3 micrograph, which was taken at a magnification of 1080×. The thermoplastic particles having embedded hollow microspheres protruding from their outer surfaces can be made by mixing the thermoplastic particles with the hollow microspheres at a temperature and for a time sufficient to soften but not melt the thermoplastic particles such that the hollow microspheres become embedded in the outer surfaces of the thermoplastic particles. The temperature and time sufficient to soften but not melt the thermoplastic particles depends upon the selected thermoplastic. To make the composition shown in FIG. 3, a mixture of high density polyethylene and hollow microspheres was mixed for 15 minutes at 116° C. at 60 rpm.

Since the thermoplastic is not melted while mixing the thermoplastic particles and hollow microspheres, individual particles of the thermoplastic particles with the hollow microspheres embedded in and protruding from their outer surfaces are not fused together. Therefore, they still behave like particles (e.g., like a powder) and have the sizes, shapes, and flow characteristics described above in any of the embodiments of the thermoplastic particles (e.g., powders). Individual particles are free to independently move and rotate. These features distinguish these particles from composites of hollow ceramic microbubbles fused together with a resin binder. The structure of the thermoplastic particles with hollow ceramic microspheres embedded in and protruding from their outer surfaces is rather unexpected. Typically, when hollow ceramic microspheres are combined with a melted thermoplastic, for example, using extrusion compounding, and then formed into pellets the hollow ceramic microspheres are located on the interior of the pellets and do not protrude from the outer surfaces of the pellets. This is due to the lower surface energy of the thermoplastic as compared to the ceramic (e.g., glass) microspheres. To reduce the overall surface energy of the system, the lower surface energy thermoplastic will be located on the exterior of the pellets, and the higher surface energy ceramic (e.g., glass) will be located on the interior of the pellets.

In some embodiments, compositions according to the present disclosure include a liquid that serves to adhere the hollow microspheres to outer surfaces of the thermoplastic particles. In some embodiments, the liquid is an oil, for example, any synthetic lubrication oil or mineral oil useful for lubrication. Useful oils include paraffinic oils, aromatic oils, naphthene oils such as those available, for example, from Process Oils Inc., Houston, Tex., and silicone oils. In some embodiments, the liquid is mineral oil. Examples of suitable mineral oils include liquid aliphatic hydrocarbon resins, mineral oil (e.g., white mineral oil), hydrogenated aromatic resins, and paraffinic oils. Such mineral oils have a molecular weight typically in a range from about 500 grams per mole to 1000 grams per mole. Examples of suitable aliphatic hydrocarbon resins are C-5 petroleum hydrocarbon resins having molecular weights from 550 grams per mole to about 900 grams per mole. Examples of suitable mineral oils are highly refined, low volatility oils which are a blend of saturated aliphatic and alicyclic non-polar hydrocarbons having an average molecular weight from 500 grams per mole to about 750 grams per mole. Examples of hydrogenated aromatic resins are resins having low molecular weights from about 800 grams per mole to 1000 grams per mole, and are derived by hydrogenation of petroleum stocks. Examples of useful paraffinic oils have 65 to 95 percent saturated hydrocarbons and from 6 to 30 percent aromatic compounds with a distillation range from about 360° C. to 540° C. Other lubricant liquids that may be useful for practicing the present disclosure are alkyl phosphates, alkyl silicates, polyglycols, polyesters, synthetic hydrocarbons and diesters, and polyphenyl ethers. In these embodiments, the liquids that serve to adhere the hollow microspheres to the surface of the thermoplastic particles can be considered non-reactive.

Materials useful in rotomolding processing typically should have adequate thermal stability to survive the long heating cycle times at elevated temperatures which are customary for rotomolding. Hence, an appropriate liquid for adhering the hollow microspheres to the thermoplastic particles may be selected based at least partially on the desired oven temperatures and heating cycle times. Silicone oils have been usually known to exhibit better thermal stability as compared to mineral oils and therefore may be useful at higher temperature. For example, while mineral oil may be useful for adhering hollow microspheres to polyethylene particles during rotomolding, silicone oil may be useful to adhere hollow glass microspheres to polyamide particles (e.g., polyamide 6 or polyamide 66) during rotomolding because of the higher melting temperature of polyamide particles. The thermal stability of various lubricant liquids described above is discussed in JACKSON, A. “Synthetic versus mineral fluids in lubrication.” Transactions of the Institution of Engineers, Australia. Mechanical engineering 14.1 (1989): 47-56, FIG. 4.

In some embodiments of compositions according to the present disclosure that include a liquid to adhere the hollow microspheres to outer surfaces of the thermoplastic particles, including any of the thermoplastic particles, hollow microspheres, and liquids described above, the compositions have up to 15 (in some embodiments, less than 15 or up to 10, 7.5, or 5) percent by weight of a liquid, based on the total weight of the composition. In some embodiments, the compositions including thermoplastic particle and hollow microspheres according to the present disclosure have a weight percent of the liquid that is up to 2, 1.5, or 1 times the weight percent of the hollow microspheres in the composition. When 15 percent or more by weight of the liquid is used in the composition, the liquid tends to bloom to the surface of the molded article, causing the surface to feel wet or oily. When the liquid is present at less than 1 times the weight percent of the hollow microspheres in the composition, there may not be enough liquid to adhere the hollow microspheres to the surfaces of the thermoplastic particles.

Compositions including thermoplastic particles and hollow microspheres disclosed herein, including dry powder compositions, can include other ingredients. For example, low-melting solids such as very low density polyethylene, petroleum jelly, hydrocarbon waxes, or mixtures thereof may be added to the compositions to help with the dispersion of hollow microspheres. In embodiments of the compositions that include a liquid, the liquid can serve to immobilize the hollow microspheres at the beginning of the molding process, for example. As the mold is heated, the low-melting solids can melt before the thermoplastic particles, providing increased opportunity for immobilizing the hollow microspheres during the molding process.

In some embodiments, the composition according to and/or useful in the method according to the present disclosure includes one or more stabilizers (e.g., UV stabilizers, antioxidants, or hindered amine light stabilizers (HALS)). Any class of UV stabilizer may be useful. Examples of useful classes of UV stabilizers include benzophenones, benzotriazoles, triazines, cinnamates, cyanoacrylates, dicyano ethylenes, salicylates, oxanilides, para-aminobenzoates, and carbon black. In some embodiments, the UV stabilizer has enhanced spectral coverage in the long-wave UV region (e.g., 315 nm to 400 nm), enabling it to block the high wavelength UV light that can cause yellowing in polymers. Examples of useful antioxidants include hindered phenol-based compounds and phosphoric acid ester-based compounds (e.g., those available from BASF, Florham Park, N.J., under the trade designations “IRGANOX” and “IRGAFOS” such as “IRGANOX 1076” and “IRGAFOS 168”, those available from Songwon Ind. Co, Ulsan, Korea, under the trade designations “SONGNOX”, and butylated hydroxytoluene (BHT)). Antioxidants, when used, can be present in an amount from about 0.001 to 1 percent by weight based on the total weight of the composition. HALS are typically compounds that can scavenge free-radicals, which can result from photodegradation or other degradation processes. Suitable HALS include decanedioic acid, bis (2,2,6,6-tetramethyl-1-(octyloxy)-4-piperidinyl)ester. Suitable HALS include those available, for example, from BASF under the trade designations “TINUVIN” and “CHIMASSORB”. Such compounds, when used, can be present in an amount from about 0.001 to 1 percent by weight based on the total weight of the composition.

Reinforcing filler may be useful in the composition according to and/or useful in the method according to the present disclosure. Reinforcing filler can be useful, for example, for enhancing the tensile, flexural, and/or impact strength of the composition. Examples of useful reinforcing fillers include silica (including nanosilica), other metal oxides, metal hydroxides, and carbon black. Other useful fillers include glass fiber, wollastonite, talc, calcium carbonate, titanium dioxide (including nano-titanium dioxide), wood flour, other natural fillers and fibers (e.g., walnut shells, hemp, and corn silks), and clay (including nano-clay). However, in some embodiments, the presence of such reinforcing fillers in the composition according to the present disclosure can lead to an undesirable increase in the density of the composition. Accordingly, in some embodiments, the composition is free of reinforcing filler or contains up to 5, 4, 3, 2, or 1 percent by weight reinforcing filler, based on the total weight of the composition.

Other additives may be incorporated into the composition disclosed herein in any of the embodiments described above. Examples of other additives that may be useful, depending on the intended use of the final molded product, include compatibilizers (e.g., including polar functional groups), impact modifiers, preservatives, mixing agents, colorants (e.g., pigments or dyes), dispersants, floating or anti-setting agents, flow or processing agents, wetting agents, anti-ozonant, and odor scavengers.

Any of the additives described above (e.g., stabilizers, fillers, and other additives such as pigments) may be useful in powder form. In some embodiments, including any of the embodiments of the powder composition described herein, the powder composition according to the present disclosure includes additive powder particles, wherein the additive is any of those described above.

The incorporation of hollow microspheres into molded articles (e.g., rotomolded articles) that is facilitated by the compositions disclosed herein provides an advantageous weight reduction. Thus, it is unnecessary for the composition to foam. Accordingly, in some embodiments, the compositions according to the present disclosure (e.g., powder compositions) and/or useful for practicing the methods disclosed herein are free of foaming agents. For example, the compositions may be free of any one of sodium bicarbonate, soda ash, nitrogen gas, nitrogen producing agents, and mixtures thereof. Also, to provide the best possible weight reduction for a given hollow microspheres, in some embodiments, the hollow microspheres (e.g., hollow glass or ceramic microspheres) are not metal coated.

In the method according to the present disclosure, the mold is typically rotated while it is heated; however, the heating and rotation do not need to be initiated simultaneously, and either the rotation or the heating can begin first. The rotation can be around one axis or two axes. In some embodiments, the rotation can be around one axis with a partial rotation or rocking motion around a second axis. In other embodiments, rotation can be carried out simultaneously around two axes. In any of these embodiments, the hollow microspheres are attached to the outer surfaces of at least some of the thermoplastic particles before heating and rotating are carried out. That is, the hollow microspheres are already attached to the outer surfaces of at least some of the thermoplastic particles when they are introduced to the mold. In some embodiments of the method disclosed herein, the method further includes cooling the mold. In some embodiments, the method further includes removing the molded article from the mold.

In some embodiments, the method according to the present disclosure includes introducing a second composition into the mold to ultimately provide a multiple-layer article. Multiple-layer articles are useful, for example, where it is desired that properties of the interior and exterior of the part differ, or where it is only necessary that one layer be made from a certain material, while the remainder of the part can be made of less expensive material. For example, double layer gasoline tanks (or other fuel tanks) may be manufactured with an interior layer having very low gasoline (or other fuel) permeability and with an exterior layer that has high impact resistance.

Rotomolding multiple-layer articles typically requires multiple steps. For example, a rotational mold is charged with a composition including thermoplastic particles, which are melted and rotated, then cooled to form the outer layer of a two-layer part. Then, a different composition including thermoplastic particles is fed into the mold, rotated, and cooled to form the inner layer. The inner polymer may have a lower melting point than the outer polymer, and the interior temperature of the mold in the second step may be held between the melting points of the two polymers so that the outer layer stays solid while the inner layer is being rotationally molded. Single charge processing may also be possible when the thermoplastic particles for the outer layer have a lower melting temperature than the thermoplastic particles for the inner layer. It may be possible to charge the rotational mold with both thermoplastic particles and then heat and rotate the mold to form the part from the single charge. The particles of the lower melting thermoplastic melt first and stick to the wall of the mold while the higher melting particles remain solid. Then, the higher melting particles melt, and rotation continues until an even interior coating is achieved. The second composition may have larger particles than the first composition so that the large particles are able to pull out of the outer layer. In other embodiments, the second composition may be placed in a plastic bag that melts before the first composition. In the method according to the present disclosure the first composition and second composition may include the same or different thermoplastic particles, and the second composition may or may not include hollow microspheres as described above in any of their embodiments. Hollow microspheres may be useful for lowering the weight of the molded product even if they are in only one layer of a multi-layer product.

Typically and advantageously, when hollow microspheres are attached to the outer surfaces of thermoplastic particles, low dusting has been observed, for example, when such compositions are added to a mold for rotational molding. A comparison of Rotomolding Example 1 with Illustrative Rotomolding Example B, Rotomolding Example 2 with Illustrative Rotomolding Example C, and Rotomolding Example 3 with Comparative Rotomolding Example D, below, demonstrates that the presence of mineral oil prevented dusting of the glass bubbles when placing the glass bubbles in the mold. A comparison of Rotomolding Example 4 with Illustrative Rotomolding Example F demonstrates that the presence of silicone oil also prevented dusting of the glass bubbles when placing the glass bubbles in the mold.

Compositions and methods according to the present disclosure allow hollow microspheres to be handled in large quantities in environments that typically offer little protection from the adverse effects of dust. Accordingly, these compositions and methods are useful for rotomolding very large objects such as pressure vessels (e.g., gas storage containers) or a component thereof (e.g., polymeric liners for composite pressure vessels), fuel tanks (e.g., automotive fuel tanks), water tanks, large collection carts (e.g., garbage collection carts), kayaks and leisure boats, playhouses, and outdoor furniture.

The compositions typically can be transported and used without significant segregation of the hollow microspheres from the thermoplastic particles. The rotomolded articles described in the Examples below had a good distribution of hollow microspheres throughout the rotomolded part. Furthermore, low hollow microsphere breakage was observed in the rotationally molded articles.

Advantageously, the compositions and methods disclosed herein can eliminate the need for compounding thermoplastic and hollow microspheres in a mixer or extruder and micropelletizing before rotomolding Since not all hollow microspheres will survive mixing, extruding, and micropelletizing, these processes typically limit the hollow microspheres that can be used. Furthermore, avoiding these costly and time-consuming steps can provide a more cost-effective manufacturing process.

Also advantageously, since the powder composition disclosed herein in any of its embodiments can be resistant to significant segregation of the hollow microspheres from the thermoplastic particles and can reduce hollow ceramic microsphere breakage in some cases, it may be compounded in an extruder (e.g., single screw or twin screw extruder), thus eliminating the need to side-feed the hollow ceramic microspheres downstream from the thermoplastic feed.

### SOME EMBODIMENTS OF THE DISCLOSURE

In a first embodiment, the present disclosure provides a method of making a molded article, the method comprising:

introducing into a mold a composition comprising thermoplastic particles and hollow microspheres, wherein the hollow microspheres are attached to outer surfaces of at least some of the thermoplastic particles;

rotating the mold; and

heating the mold at a temperature at which the thermoplastic particles melt to form the molded article comprising the hollow microspheres.

In a second embodiment, the present disclosure provides the method of the first embodiment, wherein the hollow microspheres are adhered to the outer surfaces of at least some of the thermoplastic particles with a liquid before introducing the composition into the mold.

In a third embodiment, the present disclosure provides the method of the second embodiment, wherein the liquid is a non-reactive liquid.

In a fourth embodiment, the present disclosure provides the method of the second or third embodiment, wherein the liquid is an oil.

In a fifth embodiment, the present disclosure provides the method of any one of the second to fourth embodiments, wherein the liquid comprises at least one of a mineral oil, silicone oil, paraffinic oil, aromatic oil, naphthene oil, liquid hydrocarbon resin, hydrogenated aromatic resin, alkyl phosphate, alkyl silicate, polyglycol, polyester, synthetic diester, or polyphenyl ether.

In a sixth embodiment, the present disclosure provides the method of any one of the second to fifth embodiments, wherein the liquid is mineral oil or silicone oil.

In a seventh embodiment, the present disclosure provides the method of any one of the second to sixth embodiments, wherein the composition comprises less than 15 percent by weight of the liquid, based on the total weight of the composition.

In an eighth embodiment, the present disclosure provides the method of the first embodiment, wherein the hollow microspheres are embedded in and protrude from the outer surfaces of at least some of the thermoplastic particles.

In a ninth embodiment, the present disclosure provides the method of the eighth embodiment, further comprising mixing the thermoplastic particles with the hollow microspheres at a temperature below the melting temperature of the thermoplastic particles, wherein the hollow microspheres become embedded in the outer surfaces of the thermoplastic particles.

In a tenth embodiment, the present disclosure provides the method of any one of the first to ninth embodiments, wherein the thermoplastic particles comprise at least one of a polyolefin, fluorinated polyolefin, polyamide, polyvinylchloride, polystyrene, or an acrylonitrile butadiene styrene copolymer.

In an eleventh embodiment, the present disclosure provides the method of any one of the first to tenth embodiments, wherein the thermoplastic particles comprise polyethylene, polypropylene, polyamide 6, or an acrylonitrile butadiene styrene copolymer.

In a twelfth embodiment, the present disclosure provides the method of any one of the first to eleventh embodiments, wherein the thermoplastic particles are thermoplastic powder particles.

In a thirteenth embodiment, the present disclosure provides the method of the twelfth embodiment, wherein a median size by volume of the thermoplastic powder particles is in a range from 300 micrometers to 1000 micrometers.

In a fourteenth embodiment, the present disclosure provides the method of the twelfth embodiment, wherein a median size by volume of the thermoplastic powder particles is in a range from 300 micrometers to 600 micrometers.

In a fifteenth embodiment, the present disclosure provides the method of any one of the first to fourteenth embodiments, wherein an isostatic pressure at which ten percent by volume of hollow microspheres collapses is at least 1.7 MPa.

In a sixteenth embodiment, the present disclosure provides the method of any one of the first to fifteenth embodiments, wherein an isostatic pressure at which ten percent by volume of hollow microspheres collapses is up to 17 MPa.

In a seventeenth embodiment, the present disclosure provides the method of any one of the first to sixteenth embodiments, wherein the hollow microspheres have a median size by volume in a range from 14 to 70 micrometers.

In an eighteenth embodiment, the present disclosure provides the method of any one of the first to seventeenth embodiments, wherein a median size of the thermoplastic particles is at least 3, 5, or 10 times larger than a median size of the hollow microspheres.

In a nineteenth embodiment, the present disclosure provides the method of any one of the first to eighteenth embodiments, wherein the hollow microspheres do not melt at the temperature.

In a twentieth embodiment, the present disclosure provides the method of any one of the first to nineteenth embodiments, wherein the hollow microspheres are hollow ceramic microspheres.

In a twenty-first embodiment, the present disclosure provides the method of the twentieth embodiment, wherein the hollow ceramic microspheres are hollow glass microspheres.

In a twenty-second embodiment, the present disclosure provides the method of any one of the first to twenty-first embodiments, wherein the hollow microspheres are present in the composition in a range from 0.5 percent to 20 percent by weight, based on the total weight of the composition.

In a twenty-third embodiment, the present disclosure provides the method of any one of the first to twenty-second embodiments, wherein the composition further comprises a crosslinking agent, and wherein the molded article is crosslinked.

In a twenty-fourth embodiment, the present disclosure provides the method of the twenty-third embodiment, wherein the crosslinking agent is an organic peroxide.

In a twenty-fifth embodiment, the present disclosure provides the method of any one of the first to twenty-fourth embodiments, further comprising cooling the mold.

In a twenty-sixth embodiment, the present disclosure provides the method of any one of the first to twenty-fifth embodiments, further comprising removing the molded article from the mold.

In a twenty-seventh embodiment, the present disclosure provides the method of any one of the first to twenty-sixth embodiments, further comprising:

introducing into the mold a second composition comprising second thermoplastic particles;

rotating the mold; and

heating the mold at a temperature at which the second thermoplastic particles melt.

In a twenty-eighth embodiment, the present disclosure provides the method of the twenty-seventh embodiment, wherein the second composition further comprises hollow microspheres.

In a twenty-ninth embodiment, the present disclosure provides the method of the twenty-seventh or twenty-eighth embodiment, wherein the first thermoplastic particles and the second thermoplastic particles are the same.

In a thirtieth embodiment, the present disclosure provides the method of the twenty-seventh or twenty-eighth embodiment, wherein the first thermoplastic particles and the second thermoplastic particles are different.

In a thirty-first embodiment, the present disclosure provides the method of any one of the first to thirtieth embodiments, wherein the molded article is a pressure vessel or a component of a pressure vessel, a fuel tank, a water tank, a garbage collection cart, a kayak, a playhouse, or outdoor furniture.

In a thirty-second embodiment, the present disclosure provides a powder composition comprising thermoplastic powder particles and hollow ceramic microspheres attached to outer surfaces of the thermoplastic powder particles, wherein the hollow ceramic microspheres are either adhered to the outer surfaces of at least some of the thermoplastic powder particles with a liquid or embedded in and protrude from the outer surfaces of at least some of the thermoplastic powder particles.

In a thirty-third embodiment, the present disclosure provides a powder composition comprising a mixture of thermoplastic powder particles and hollow ceramic microspheres, wherein the hollow ceramic microspheres are adhered to outer surfaces of the thermoplastic powder particles with a liquid.

In a thirty-fourth embodiment, the present disclosure provides the powder composition of the thirty-second or thirty-third embodiment, wherein the liquid is a non-reactive liquid.

In a thirty-fifth embodiment, the present disclosure provides the powder composition of the thirty-fourth embodiment, wherein the liquid is an oil.

In a thirty-sixth embodiment, the present disclosure provides the powder composition of any one of the thirty-second to thirty-fifth embodiments, wherein the liquid comprises at least one of a mineral oil, silicone oil, paraffinic oil, aromatic oil, naphthene oil, liquid hydrocarbon resin, hydrogenated aromatic resin, alkyl phosphate, alkyl silicate, polyglycol, polyester, synthetic diester, or polyphenyl ether.

In a thirty-seventh embodiment, the present disclosure provides the powder composition of any one of the thirty-second to thirty-sixth embodiments, wherein the liquid is mineral oil or silicone oil.

In a thirty-eighth embodiment, the present disclosure provides the powder composition of any one of the thirty-second to thirty-seventh embodiments, wherein the composition comprises less than 15 percent by weight of the liquid, based on the total weight of the composition.

In a thirty-ninth embodiment, the present disclosure provides a powder composition comprising a mixture of thermoplastic powder particles and hollow ceramic microspheres, wherein the hollow ceramic microspheres are embedded in and protrude from the outer surfaces of at least some of the thermoplastic powder particles.

In a fortieth embodiment, the present disclosure provides the powder composition of any one of the thirty-second to thirty-ninth embodiments, wherein the thermoplastic powder particles comprise at least one of a polyolefin, fluorinated polyolefin, polyamide, polyvinylchloride, polystyrene, or an acrylonitrile butadiene styrene copolymer.

In a forty-first embodiment, the present disclosure provides the powder composition of any one of the thirty-second to fortieth embodiments, wherein the thermoplastic powder particles comprise polyethylene, polypropylene, polyamide 6, or an acrylonitrile butadiene styrene copolymer.

In a forty-second embodiment, the present disclosure provides the powder composition of any one of the thirty-second to forty-first embodiments, wherein a median size by volume of the thermoplastic powder particles is in a range from 300 micrometers to 1000 micrometers.

In a forty-third embodiment, the present disclosure provides the powder composition of any one of the thirty-second to forty-first embodiments, wherein a median size by volume of the thermoplastic powder particles is in a range from 300 micrometers to 600 micrometers.

In a forty-fourth embodiment, the present disclosure provides the powder composition of any one of the thirty-second to forty-third embodiments, wherein an isostatic pressure at which ten percent by volume of hollow ceramic microspheres collapses is at least 1.7 MPa.

In a forty-fifth embodiment, the present disclosure provides the powder composition of any one of the thirty-second to forty-fourth embodiments, wherein an isostatic pressure at which ten percent by volume of hollow ceramic microspheres collapses is up to 17 MPa.

In a forty-sixth embodiment, the present disclosure provides the powder composition of any one of the thirty-second to forty-fifth embodiments, wherein the hollow ceramic microspheres have a median size by volume in a range from 14 to 70 micrometers.

In a forty-seventh embodiment, the present disclosure provides the powder composition of any one of the thirty-second to forty-sixth embodiments, wherein the median size of the thermoplastic powder particles is at least 3, 5, or 10 times larger than the median size of the hollow ceramic microspheres.

In a forty-eighth embodiment, the present disclosure provides the powder composition of any one of the thirty-second to forty-seventh embodiments, wherein the hollow ceramic microspheres are hollow glass microspheres.

In a forty-ninth embodiment, the present disclosure provides the powder composition of any one of the thirty-second to forty-eighth embodiments, wherein the hollow ceramic microspheres are present in the composition in a range from 0.5 percent to 20 percent by weight, based on the total weight of the composition.

In a fiftieth embodiment, the present disclosure provides the powder composition of any one of the thirty-second to forty-ninth embodiments, further comprising a crosslinking agent. The crosslinking agent may be in powder form.

In a fifty-first embodiment, the present disclosure provides the powder composition of the fiftieth embodiment, wherein the crosslinking agent is an organic peroxide.

In a fifty-second embodiment, the present disclosure provides the powder composition of any one of the thirty-second to fifty-first embodiment, further comprising at least one of a stabilizer, filler, or pigment in powder form.

In a fifty-third embodiment, the present disclosure provides the method or powder composition of any one of the first to fifty-second embodiments, wherein a median size of the thermoplastic particles up to 100, 75, or 50 times larger than a median size of the hollow microspheres.

In a fifty-fourth embodiment, the present disclosure provides the method or powder composition of any one of the first to fifty-third embodiments, wherein the composition or powder composition does not include a foaming agent.

In a fifty-fifth embodiment, the present disclosure provides the method or powder composition of any one of the first to fifty-fourth embodiments, wherein the hollow microspheres are not metal coated.

In a fifty-sixth embodiment, the present disclosure provides a kayak comprising hollow microspheres. The hollow microspheres can be polymeric or ceramic (e.g., glass) microspheres.

In a fifty-seventh embodiment, the present disclosure provides a pressure vessel comprising hollow microspheres. The hollow microspheres can be polymeric or ceramic (e.g., glass) microspheres. The hollow microspheres may be present in at least one component of the pressure vessel, such as a liner for a composite pressure vessel. The pressure vessel may be a gas storage container.

In a fifty-eighth embodiment, the present disclosure provides a garbage collection cart comprising hollow microspheres. The hollow microspheres can be polymeric or ceramic (e.g., glass) microspheres.

In a fifty-ninth embodiment, the present disclosure provides a playhouse or portion thereof comprising hollow microspheres. The hollow microspheres can be polymeric or ceramic (e.g., glass) microspheres.

### EXAMPLES

The following specific, but non-limiting, examples will serve to illustrate the present disclosure.

### Test Methods

### Density

Density of the molded parts was determined using the following procedure. First, the molded parts were exposed to high temperature in an oven (Nabertherm® N300/14) in order to volatilize the polymer resin. The oven was set with a temperature ramp profile to run from 200° C. to 550° C. in 5 hours. After the temperature reached 550° C., it was kept constant for 12 hours. Weight percent of glass bubbles was calculated from the known amounts of molded part before and after the burn process using the following equation:

Weight % of Glass Bubbles=(Weight of Residual Inorganics After Burn)/(Weight of Molded Material Before Burn)×100

We then determine the density of the glass bubble residue (d_{GB}) using a helium gas pycnometer (AccuPcy 1330 from Micromeritics). Finally, the molded part density is calculated from the known weight percent of glass bubble residue (W % GB), weight percent of polymer phase (1-w % GB), the density of glass bubble residue (d_{GB}) and the known polymer density (d_{polymer}) from supplier datasheet.

$${ρ}_{molded part} = \frac{1}{\frac{W {\%}_{GB}}{{d}_{GB}} + \frac{W {\%}_{polymer}}{{d}_{polymer}}}$$

### Morphology

Morphology of the mixture of glass bubbles (GB) and polymers was examined with a scanning electron microscopy (SEM) system from FEI™ (Hillsboro, Oreg.).

### Illustrative Powder Example

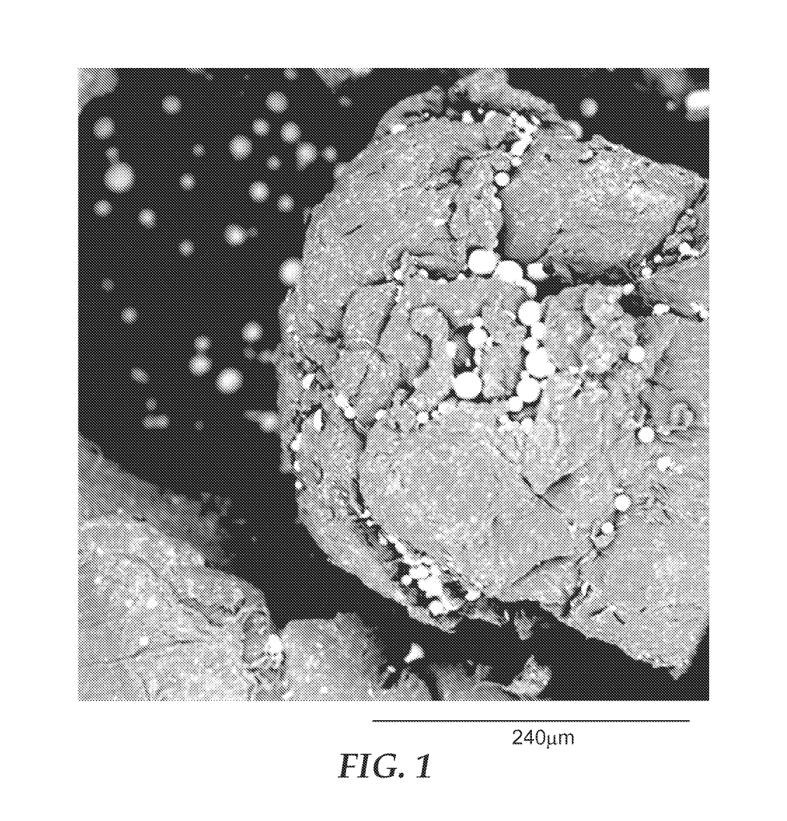

23.75 pounds (10.77 kg) of a high density polyethylene resin (HDPE) copolymer with hexene with a melt flow index of 2.0 at 190° C. and under a load of 2.16 kg (obtained as a powder from EXXONMOBIL Chemical Company, Houston, Tex., under the trade designation “HDPE HD8660”) and 1.25 pounds (0.567 kg) of glass bubbles (GB) having a density of 0.49 g/cc (from 3M COMPANY, St. Paul, Minn., under the trade designation “iM16K GLASS BUBBLES”) were placed in a mixer (130-Liter Pilot Batch Mixer/Dryer obtained from Littleford Day, Inc., Florence Ky., under the model no FM-130-D Ploughshare). The HDPE/GB mixture was mixed for 5 minutes at 25° C. at 60 rpm. After 5 minutes of mixing, the mixture was discharged from the mixer and samples were collected for SEM analysis. The HDPE/GB mixture was observed to be a free flowing powder. However, airborne dust formation was observed when the mixing chamber was first opened. The morphology shown in FIG. 1 indicated no significant physical or chemical bonding between GB particles and HDPE powders. GB-1 particles were observed to be located in the cavities present on the as-received HDPE powder particles.

### Powder Composition Example 1

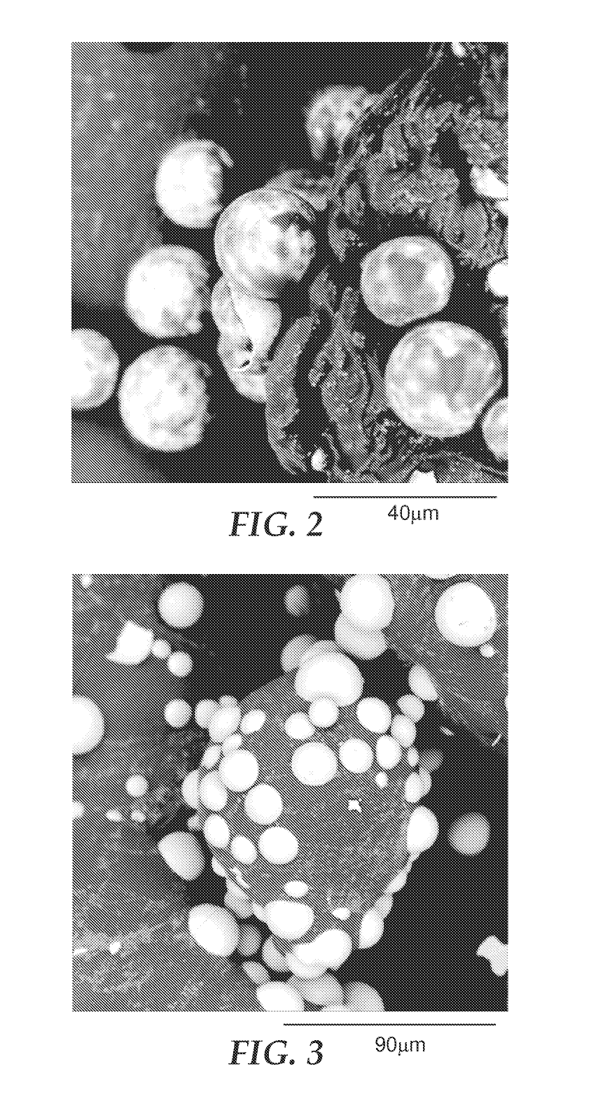

Example 1 was prepared, mixed, and analyzed by SEM using the method of the Illustrative Example with the following modifications. 22.5 pounds (10.2 kg) of the HDPE were used. 1.25 pounds (0.567 kg) of U.S.P. grade mineral oil (obtained from Paddock Laboratories, Inc., Minneapolis, Minn., as “N.D.C. 0574-0618-16”) was poured on the powder mixture in the mixer. After mixing, the mixture of HDPE, GB, and mineral oil was observed to be a free flowing powder. No airborne dust formation was observed when the mixing chamber was first opened. The morphology shown in FIG. 2 indicates that mineral oil facilitated bonding of the glass bubbles onto the HDPE powder particles.

### Powder Composition Example 2

Example 1 was prepared, mixed, and analyzed by SEM using the method of the Illustrative Example with the following modifications. The mixture of HDPE and glass bubbles was mixed for 15 minutes at 116° C. at 60 rpm. After 15 minutes of mixing, the mixture was discharged from the mixer and samples were collected for SEM analysis. The mixture of HDPE and glass bubbles was observed to be a free flowing powder. No airborne dust formation was observed when the mixing chamber was first opened. The morphology shown in FIG. 3 indicates mixing at 116° C. facilitate unexpected bonding of the glass bubbles onto the HDPE powder particles.

### Comparative Rotomolding Example A

A box-shaped, cast aluminum mold with inner dimensions of 30.5×30.5×30.5 cm and with a mold wall thickness of 1 cm was used in the Rotomolding Examples. The mold lid was portably attached to the rest of the mold with screws, so that it can be completely taken off for loading and unloading of the mold. A shuttle type rotomolder (′ Shuttle PD′ from Plastics Consulting Inc., Palm City, Fla.), which was equipped with natural gas burning oven, cooling fan, water-cooling mist spray, and external nitrogen supply line, was used in the Rotomolding Examples. The mold, oven, and air temperature inside the mold were tracked in real time with a data logger (available under the trade name ‘Tpaq 21’ from DATAPAQ Inc., Derry, N.H., USA) equipped with a RF transmitter. The real time recorded temperature data were remotely transmitted to an RF receiver which was connected to a computer. The data logger was placed in a protective housing and two frozen freezer packs were placed on both sides of the data logger in order to protect the sensitive electronics parts of the data logger from the high temperatures in the oven. The mold was equipped with two vent tubes made of poly(tetrafluoroethylene), (PTFE) which were attached to the mold lid and which were filled with glass wool.

Before starting the cycle, 1.6 kg of HDPE (a copolymer with hexene with a melt flow index of 2.0 at 190° C. and under a load of 2.16 kg, obtained as a powder from EXXONMOBIL Chemical Company, under the trade designation “HDPE HD8660”) was placed in the mold. No substantial dust formation was observed when placing the powder in the mold. The oven temperature was set to 343° C., and it was monitored with the data logger. During rotational molding, the arm speed was set to 8 rpm and the plate speed was set to 2 rpm. When the air temperature inside the mold (inside air temperature—IAT) reached 204° C., the mold was moved to the cooling chamber. In the cooling chamber, a three-step cooling procedure was used. First, a fan was used to blow air at ambient temperature on the mold for the initial 12 minutes of the cooling cycle. The ambient air temperature in the laboratory was measured to be approximately 24° C. during the experiments. In the entire cooling cycle, the rotation rates of the mold were kept same as those used in heating cycle. After 12 minutes, the second step of the cooling cycle was initiated. The fan was shut off and water mist at 25° C. was started to be sprayed on the mold. The water spray more rapidly cooled down the mold. The water was sprayed for the next 8 minutes. After 8 minutes, the third step of the cooling cycle was initiated. Water spray was shut off and the fan was turned on to dry the water left on the mold. The third step of the cooling cycle lasted for 3 minutes. After completion of the third step of the cooling cycle, the fan was shut off, the mold rotation was stopped, and the part was taken out of mold. Then, the part was cut open and analyzed. The density of the part is shown in Table 1.

### Illustrative Rotomolding Example B

Illustrative Rotomolding Example B was carried out as described for Comparative Rotomolding Example A with the modification that before molding, 80 grams of glass bubbles obtained from 3M Company under the trade designation “iM16K GLASS BUBBLES” were mixed with 1.52 kg of the HDPE by placing them in a plastic bag and shaking the bag rigorously for one minute. This mixture was then placed in the mold. Substantial dust formation was observed when placing the powder in the mold. The density of the part is shown in Table 1.

### Rotomolding Example 1

Rotomolding Example 1 was carried out as described for Comparative Rotomolding Example A with the modification that before molding, 80 grams of glass bubbles obtained from 3M Company under the trade designation “iM16K GLASS BUBBLES” and 80 grams of mineral oil obtained from Paddock Laboratories, Inc. as “N.D.C. 0574-0618-16” were mixed with 1.44 kg of the HDPE by placing them in a plastic bag and shaking the bag rigorously for one minute. This mixture was then placed in the mold. No substantial dust formation was observed when placing the powder in the mold. The density of the part is shown in Table 1.

### Illustrative Rotomolding Example C

Illustrative Rotomolding Example C was carried out as described for Comparative Rotomolding Example A with the modification that before molding, 16 grams of glass bubbles having a density of 0.125 g/cc obtained from 3M Company under the trade designation “K1 GLASS BUBBLES” were mixed with 1.58 kg of the HDPE by placing them in a plastic bag and shaking the bag rigorously for one minute. This mixture was then placed in the mold. Substantial dust formation was observed when placing the powder in the mold. The density of the part is shown in Table 1.

### Rotomolding Example 2

Rotomolding Example 2 was carried out as described for Comparative Rotomolding Example A with the modification that before molding, 16 grams of glass bubbles obtained from 3M Company under the trade designation “K1 GLASS BUBBLES” and 240 grams of mineral oil obtained from Paddock Laboratories, Inc. as “N.D.C. 0574-0618-16” were mixed with 1.34 kg of the HDPE by placing them in a plastic bag and shaking the bag rigorously for one minute. This mixture was then placed in the mold. No substantial dust formation was observed when placing the powder in the mold. The density of the part is shown in Table 1. The molded article exhibited significantly non-uniform filler dispersion. Undispersed filler agglomerates were visually apparent in the article. In addition, inspection of molded article with bare hands revealed the presence of substantial amounts of mineral oil on the part surface.

### Illustrative Rotomolding Example D

Illustrative Rotomolding Example D was carried out as described for Comparative Rotomolding Example A with the modification that before molding, 80 grams of hollow glass microspheres having a density of 1.10 g/cc obtained from Potters Industries LLC, Valley Force, Pa., under the trade designation “110P8” were mixed with 1.52 kg of the HDPE by placing them in a plastic bag and shaking the bag rigorously for one minute. This mixture was then placed in the mold. Substantial dust formation was observed when placing the powder in the mold. The density of the part is shown in Table 1.

### Rotomolding Example 3

Rotomolding Example 3 was carried out as described for Comparative Rotomolding Example A with the modification that before molding, 80 grams of hollow glass microspheres obtained from Potters Industries LLC under the trade designation “110P8” and 80 grams of mineral oil obtained from Paddock Laboratories, Inc. as “N.D.C. 0574-0618-16” were mixed with 1.44 kg of the HDPE by placing them in a plastic bag and shaking the bag rigorously for one minute. This mixture was then placed in the mold. No substantial dust formation was observed when placing the powder in the mold. The density of the part is shown in Table 1.

### Comparative Rotomolding Example E

Comparative Rotomolding Example E was carried out as described for Comparative Rotomolding Example A with the following modifications. Before starting the cycle, 1.6 kg of polyamide 6 having a melt flow index of 2.0 at 190° C. and under the load of 2.16 kg obtained from Koninklijke DSM N.V., The Netherlands, under the trade designation “ICORENE FUEL LOCK 7620” was placed in the mold instead of the HDPE. No substantial dust formation was observed when placing the powder in the mold. The oven temperature was set to 371° C. and it was monitored with the data logger. When the air temperature inside the mold reached 218° C., the mold was moved to the cooling chamber. The same three cooling cycles as described in Comparative Rotomolding Example A were used except the water mist was sprayed for 15 minutes. The density of the part was presented in Table 1. The rotomolded part exhibited yellow-brownish discoloration. The color observed on the outside surface was significantly lighter as compared to that observed on the inside surface.

### Illustrative Rotomolding Example F

Illustrative Rotomolding Example F was carried out as described for Comparative Rotomolding Example E with the modification that before molding, 16 grams of glass bubbles obtained from 3M Company under the trade designation “K1 GLASS BUBBLES” were mixed with 1.58 kg of the polyamide 6 by placing them in a plastic bag and shaking the bag rigorously for one minute. This mixture was then placed in the mold. Substantial dust formation was observed when placing the powder in the mold. The entire heating cycle was performed under nitrogen gas flow. A nitrogen air flow at 7 kPa was supplied into the mold via the nitrogen flow line which was connected to the mold through one of the vent tubes. The nitrogen gas flow substantially prevented discoloration on the inside surface. The density of the part is shown in Table 1.

### Rotomolding Example 4

Rotomolding Example 4 was carried out as described for Comparative Rotomolding Example F with the modification that before molding, 16 grams of glass bubbles obtained from 3M Company under the trade designation “K1 GLASS BUBBLES” and 80 grams of silicone fluid obtained from Dow Chemical Company, Midland, Mich., under the trade designation “SYLTHERM 800” were mixed with 1.50 kg of the polyamide 6 by placing them in a plastic bag and shaking the bag rigorously for one minute. This mixture was then placed in the mold. No substantial dust formation was observed when placing the powder in the mold. The entire heating cycle was performed under the nitrogen air flow described in Comparative Rotomolding Example F. The density of the part is shown in Table 1.

### Illustrative Rotomolding Example G

Illustrative Rotomolding Example G was carried out as described for Illustrative Rotomolding Example F with the modification that before molding, 80 grams of glass bubbles obtained from 3M Company under the trade designation “iM16K GLASS BUBBLES” were mixed with 1.52 kg of the polyamide 6 by placing them in a plastic bag and shaking the bag rigorously for one minute. This mixture was then placed in the mold. Substantial dust formation was observed when placing the powder in the mold. The entire heating cycle was performed under the nitrogen air flow described in Illustrative Rotomolding Example F. The density of the part is shown in Table 1.

TABLE 1

| Rotomolding | | Density |
|---|---|---|
| Example | Formulation | (g/cc) |
| Comp. Ex. A | HDPE | 0.940 |
| Ill. Ex. B | HDPE + “iM16K GLASS BUBBLES” | 0.893 |
| Ex. 1 | HDPE + “iM16K GLASS BUBBLES” + | 0.890 |
| | mineral oil | |
| Ill. Ex. C | HDPE + 1 wt % “K1 GLASS BUBBLES” | 0.883 |
| Ex. 2 | HDPE + 1 wt % “K1 GLASS BUBBLES” + | 0.884 |
| | 15 wt % mineral oil | |
| Ill. Ex. D | HDPE + “110P8” glass bubbles | 0.947 |
| Ex. 3 | HDPE + “110P8” glass bubbles + | 0.943 |
| | mineral oil | |
| Comp. Ex. E | Polyamide 6 | 1.050 |
| Ill. Ex. F | Polyamide 6 + “K1 GLASS BUBBLES” | 0.978 |
| Ex. 4 | Polyamide 6 + “K1 GLASS BUBBLES” + | 0.973 |
| | “SYLTHERM 800” silicone fluid | |
| Ill. Ex. G | Polyamide 6 + “iM16K GLASS BUBBLES” | 0.987 |

### Illustrative Rotomolding Example H

The objective of this example was to make multi-layered rotomolded articles. The described article in this example was obtained by sequentially loading the mold. In Illustrative Rotomolding Example H, the same mold and equipment described in Comparative Example A were used.

Before molding, two batches of materials were prepared. First, 910 grams of pristine HDPE (a copolymer with hexene with a melt flow index of 2.0 at 190° C. and under a load of 2.16 kg, obtained as a powder from EXXONMOBIL Chemical Company, under the trade designation “HDPE HD8660”) were weighed to obtain the first batch. Second, 34 grams of glass bubbles obtained from 3M Company under the trade designation “iM16K GLASS BUBBLES” were mixed with 646 grams of HDPE (“HDPE HD8660”) by placing them in a plastic bag and shaking the bag rigorously for one minute to obtain the second batch. The first batch of pristine HDPE was placed in the mold. The oven temperature was set to 343° C. and it was monitored with the data logger. During rotational molding of the first batch, the arm speed was set to 8 rpm and the plate speed was set to 2 rpm. When the air temperature inside the mold (inside air temperature—IAT) reached 193° C., the mold was moved to the cooling chamber and mold rotation was stopped. Then, the second batch (HDPE+glass bubbles powder mixture) was loaded to the mold with the help of a funnel through a small hatch on the mold lid which can be manually opened and closed. After charging the second batch, the hatch on the lid was closed, the mold was sent back to the oven, and mold rotation was started once again. Moving the mold out of the oven and charging the second batch, which was at ambient temperature of 24° C., reduced the IAT. After moving the mold back to oven, the IAT was kept monitored and when it reached 193° C. once again, the mold was moved back to the cooling chamber. The three-step cooling cycle described in Comparative Example A was used. After completion of the third step of the cooling cycle, the fan was shut off, the mold rotation was stopped, and the part was taken out of mold. Then, the part was cut open and analyzed. A two-layered structure was observed. Multi-layered articles which contained more than two layers can easily be obtained by adding additional batches to the mold as described above as many times as necessary.

This disclosure is not limited to the above-described embodiments but is to be controlled by the limitations set forth in the following claims and any equivalents thereof. This disclosure may be suitably practiced in the absence of any element not specifically disclosed herein.

1. A method of making a molded article, the method comprising:
introducing into a mold a composition comprising thermoplastic particles and hollow microspheres, wherein the hollow microspheres are adhered to outer surfaces of at least some of the thermoplastic particles with a liquid before introducing the composition into the mold;
rotating the mold; and
heating the mold at a temperature at which the thermoplastic particles melt to form the molded article comprising the hollow microspheres.

2. (canceled)

3. The method of claim 1, wherein the liquid is an oil.

4. The method of claim 3, wherein the composition comprises less than 15 percent by weight of the liquid, based on the total weight of the composition.

5. The method of claim 1, wherein the liquid comprises at least one of a mineral oil, silicone oil, paraffinic oil, aromatic oil, naphthene oil, liquid hydrocarbon resin, hydrogenated aromatic resin, alkyl phosphate, alkyl silicate, polyglycol, polyester, synthetic diester, or polyphenyl ether.

6. The method of claim 5, wherein the liquid is mineral oil or silicone oil.

7. The method of claim 1, wherein the thermoplastic particles are thermoplastic powder particles with a median size by volume in a range from 300 micrometers to 1000 micrometers.

8. The method of claim 1, further comprising:
introducing into the mold a second composition comprising second thermoplastic particles;
rotating the mold; and
heating the mold at a second temperature at which the second thermoplastic particles melt.

9. The method of claim 1, wherein the molded article is a pressure vessel or component of a pressure vessel, a fuel tank, a water tank, a garbage collection cart, a kayak, a playhouse or portion thereof, or outdoor furniture.

10. A powder composition comprising thermoplastic powder particles and hollow ceramic microspheres attached to outer surfaces of at least some of the thermoplastic powder particles, wherein the hollow ceramic microspheres are adhered to the outer surfaces of at least some of the thermoplastic powder particles with a liquid.

11. The powder composition of claim 10, wherein the thermoplastic powder particles have a median size by volume in a range from 300 micrometers to 600 micrometers.

12. The powder composition of claim 10, wherein the thermoplastic particles comprise polyethylene, polypropylene, polyamide 6, or an acrylonitrile butadiene styrene copolymer.

13. The powder composition of claim 10, wherein the hollow microspheres are hollow glass microspheres.

14. The powder composition of claim 10, wherein an isostatic pressure at which ten percent by volume of the hollow microspheres collapses is up to 17 MPa.

15. The powder composition of claim 10, wherein the composition further comprises at least one of a crosslinking agent, a stabilizer, or a pigment.

16. The powder composition of claim 10, wherein the liquid is an oil.

17. The powder composition of claim 10, wherein the liquid comprises at least one of a mineral oil, silicone oil, paraffinic oil, aromatic oil, naphthene oil, liquid hydrocarbon resin, hydrogenated aromatic resin, alkyl phosphate, alkyl silicate, polyglycol, polyester, synthetic diester, or polyphenyl ether.

18. The method of claim 1, wherein the thermoplastic particles comprise polyethylene, polypropylene, polyamide 6, or an acrylonitrile butadiene styrene copolymer.

19. The method of claim 1, wherein the hollow microspheres are hollow glass microspheres.

20. The method of claim 1, wherein an isostatic pressure at which ten percent by volume of the hollow microspheres collapses is up to 17 MPa.

21. The method of claim 1, wherein the composition further comprises at least one of a crosslinking agent, a stabilizer, or a pigment.
